(19) United States
(12) Patent Application Publication
(10) Pub. No.: US 2007/0116565 A1
(43) Pub. Date: May 24, 2007

(54) System for producing electricity through the action of waves on floating platforms

(76) Inventor: Glenn Beane, Hanover, NH (US)

Correspondence Address: DEVINE, MILLIMET & BRANCH, P.A., 111 AMHERST STREET, BOX 719, MANCHESTER, NH, 03105, US

(21) Appl. No.: 11/593,895

(22) Filed: Nov. 7, 2006

Related U.S. Application Data
(60) Provisional application No. 60/734,203, filed on Nov. 7, 2005.

(51) Int. Cl. F03D 7/02; F03B 7/00

(52) U.S. Cl. 416/11

(57) ABSTRACT

The present invention is a system and method for producing electricity through the action of waves on floating platforms. The hydraulic force of the water in the waves causes the platform to create a series of reverse incline planes. As a mass moves down the reverse incline planes, it gains mechanical energy, which mechanical energy is converted into electrical energy.

### CROSS-REFERENCE TO RELATED APPLICATIONS

This Application claims the benefit of U.S. Provisional Patent Application 60/734,203, filed Nov. 7, 2005, which is incorporated herein by reference.

### FIELD OF THE INVENTION

The present invention is a system and method for producing electricity. More particularly, it is a system and method for producing electricity through the action of waves on floating platforms.

### BACKGROUND OF THE INVENTION

There are numerous approaches to producing electricity from the hydraulic force of the localized movement of water in large bodies of water. Water moving as a result of tides, winds or gravity, for example, has been used as a hydraulic force to move some turbine, door or other part of a larger apparatus anchored to land. This approach is expensive, not very efficient and prone to breaking down both because of the difficulty in anchoring the apparatus to land and because the ocean is corrosive and small sand particles in it cause excessive wear.

The present invention does not rely on stationary machinery, but produces electricity through the hydraulic force of the water in waves on floating platforms.

### SUMMARY OF THE INVENTION

The present invention is a system and method for producing electricity through the action of waves on floating platforms. A mass is placed on a floating platform having a leading edge and a trailing edge. Waves then alternately raise the leading edge of the platform over the trailing edge and the trailing edge of the platform over the leading edge, thereby creating a series of reverse incline planes. As the mass moves down the reverse incline planes, it gains mechanical energy. Then, the mechanical energy of the moving mass is converted into electrical energy.

### BRIEF DESCRIPTION OF THE DRAWINGS

These and other features and advantages of the present invention will be better understood by reading the following detailed description of embodiments, taken together with the drawings wherein:

FIG. 1 is a schematic diagram of the reverse incline planes produced by a wave;

FIG. 2 is a schematic diagram of a ship incorporating one of the incline planes produced by a wave as shown in FIG. 1;

FIG. 3 is a schematic diagram of a moving mass on the incline plane of the ship shown in FIG. 2;

FIG. 4 is a schematic diagram of a rolling cylinder on the incline plane of the ship shown in FIG. 2;

FIG. 5 is a diagram of a mass comprised of two substantially cylindrical masses.

FIG. 6 is a schematic diagram of a rolling wheeled vehicle on the incline plane of the ship shown in FIG. 2;

FIG. 7 is a schematic diagram of a moving liquid on the incline plane of the ship shown in FIG. 2; and

FIG. 8 is a schematic diagram of an electromagnetically suspended mass on the incline plane of the ship shown in FIG. 2.

### DETAILED DESCRIPTION OF EMBODIMENTS

Two-thirds of the earth's surface is covered with water. Three-fourths of the earth's population lives within close proximity to an ocean or other large body of water. All of these people need electricity.

The wind blowing on the surface of an ocean or other large body of water (hereinafter, collectively, the “Ocean”) efficiently converts wind energy into wave energy. The present invention is a system for converting the energy of waves on the Ocean into low-cost, efficient, reliable, clean electricity.

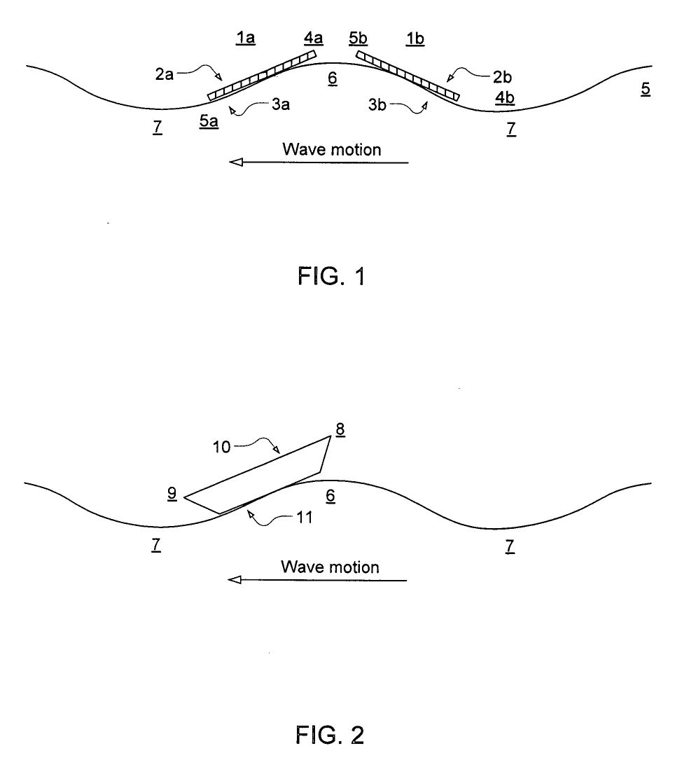

Wave energy can be converted into useful mechanical energy through the hydraulic force of the water in a wave causing a floating platform to act as a series of incline planes. As shown in a preferred embodiment in FIG. 1, a floating platform 1a has a top surface 2a and a bottom surface 3a. The top surface 2a has a leading edge 4a and a trailing edge 5a. As the crest 6 of a wave reaches the leading edge 4a of the platform 1a, the hydraulic force of the water raises the leading edge 4a relative to the trailing edge 5a creating an incline plane. As the crest 6 of the wave passes under the platform (now shown as) 1b, the hydraulic force of the water no longer raises the leading edge 4b, which now falls into the trough 7 of the wave, relative to the trailing edge 5b. The hydraulic force of the water now raises the trailing edge 5b relative to the leading edge 4b creating another incline plane. For purposes of this description, an incline plane first with its leading edge higher than its trailing edge and then with its leading edge lower than its trailing edge, will be described as the reverse of each other. Thus, the action of the moving waves causes a series of incline planes, any given incline plane being the reverse of both the incline plane that precedes it and the incline plane that follows it.

It should be noted that the platform 1a with a bottom 3a that is flat both in the direction of the motion of the waves and transverse to the motion of the waves, as opposed to rounded or v-shaped, is a more efficient incline plane. It should also be noted that the length of the incline plane formed by a floating platform, from the leading edge 8 (bow) to the trailing edge 9 (stern), can be increased by raising the top surface 10 of the platform relative to the bottom surface 11 of the platform, as would customarily be the case of the deck of a ship 10 relative to its hull 11, as shown for one embodiment in FIG. 2.

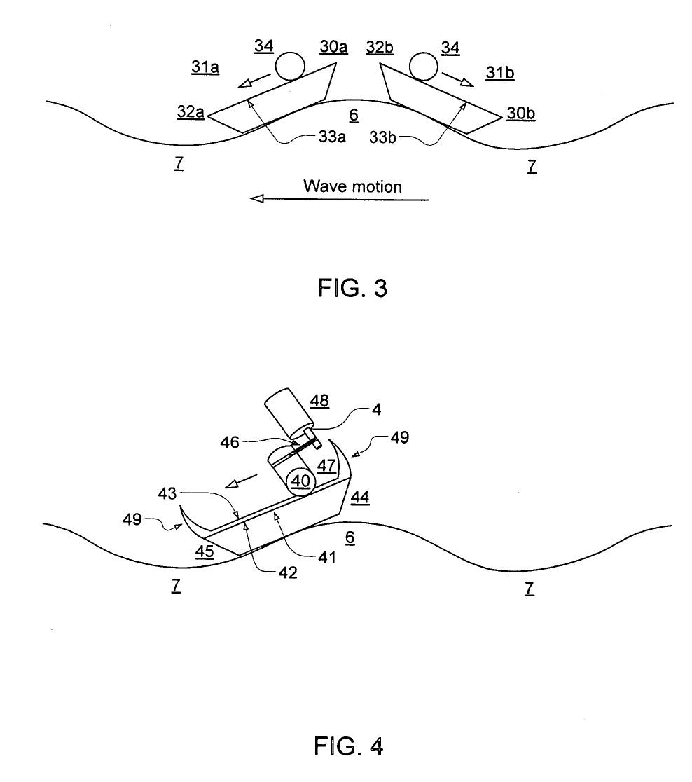

The energy of a series of moving waves is converted into mechanical energy through the movement of a mass down a series of reverse incline planes formed by the hydraulic force of the water in the waves on a ship's hull. As is discussed below, the mass may be solid or liquid and may take any one of a number of forms known to those skilled in the art. As shown for a preferred embodiment in FIG. 3, as the crest 6 of a wave raises the bow 30a of a ship 31a relative to the stem 32a, it creates an incline plane 33a. The force of gravity then causes a mass 34 to move down the incline plane 33a from the bow 30a to the stem 32a. As the crest 6 of the wave passes under the ship, the bow (now shown as) 30b of the ship 31b sinks relative to the stem 32b, into the trough 7 of the wave creating a reverse incline plane. The force of gravity now causes the mass 33 to move down the reverse incline plane 33b from the stem 32b to the bow 30b. It should be noted that a ship embodying these principles may be positioned transverse to the direction of the wave motion causing a mass to move down reversing incline planes from one side of the ship to the other.

The greater the mass 33 moving down the incline planes, the greater the mechanical energy created. It should be noted that this source of energy is renewable because the waves continuously create reverse incline planes, causing the mass 33 to repeat continuously its motion from the bow to the stem and back to the bow.

The energy of the mass moving down the series of reverse incline planes is converted by known means into electrical energy using a generator. One ft. lb. of force per second equals 1.356 watts of electricity; so, the amount of force required to move 1.0 lb a distance of 1.0 ft. in 1.0 second is equal to 1.356 watts of electricity. As an example, 100,000 ft. lb. of force per second created by a mass moving down an incline plane equals 135,600 watts of electricity. Preferred embodiments of means for converting the mechanical energy of the moving waves to electrical energy are described below, but other means known to those skilled in the art are available.

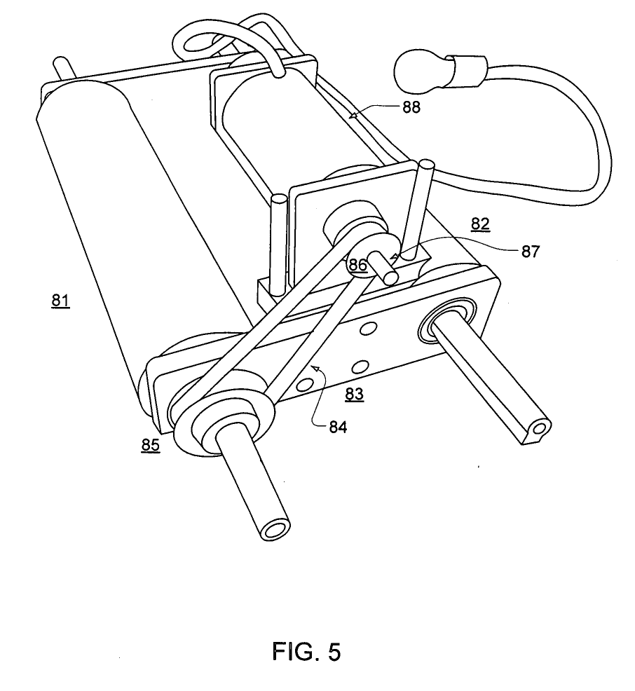

In one embodiment, as shown in FIG. 4, a cylinder 40 of a suitable, preferably dense solid material or a hollow cylinder filled with a suitable, preferably dense liquid rolls down an incline plane 41 on the deck of a ship 42 on rails 43 attached to the incline plane 41 from the bow 44 to the stem 45 of the ship. The rails 43 minimize friction between the cylinder 40 and the incline plane 41 causing the cylinder 40 to roll faster, thereby creating more mechanical energy. Sprockets and chains or similar means (not shown) can be used to prevent the cylinder 40 from sliding down the incline plane 41 instead of rolling.

A belt drive 46 is fastened around the circumference of the cylinder 40 and attached to the shaft 47 of an electric generator 48. As the cylinder 40 rolls down the incline plane 41, it turns the shaft 47 of the generator 48, producing electricity. The revolutions per minute of the cylinder 40 can be controlled by varying the diameter of the cylinder 40 and the shaft 47 of the generator 48, or by using gears and other means known to those skilled in the art.

As also shown on FIG. 4, when the cylinder 40 reaches the end of the incline plane 41, if it is still rolling, any residual mechanical energy can be temporarily stored by having the cylinder 40 roll up a radius 49 until it stops. When the incline plane 41 reverses, the mass 40 initially travels down the radius 49, releasing stored mechanical energy prior to rolling down the reverse incline plane. Alternatively, if the mass 40 is still rolling at the end of the incline plane 41, electricity can be generated through the use of a braking device (not shown), known to those skilled in the art, that co-generates electricity as it stops the mass 40.

In still another embodiment, as shown in FIG. 5, two substantially cylindrical masses 81, 82 are connected by a frame 83. A belt drive 84 is connected to a sprocket 85 on an extension of one of the cylindrical masses 81 and a sprocket 86 on the shaft 87 of an electrical generator 88. As the cylindrical masses 81, 82 roll down the reverse incline planes, they turn the shaft 87 of the generator 88 producing electricity.

A prototype of the present invention, as shown in FIG. 5 comprises custom stainless steel construction of the cylindrical masses 81, 82 and frame 83. The belt drive 84 and timing gear (not shown) were purchased from Stock Drive Products of New Hyde Park, N.Y., and the generator is a low RPM permanent magnet DC generator purchased from Windstream Power, LLC of North Ferrisburgh, Vt.

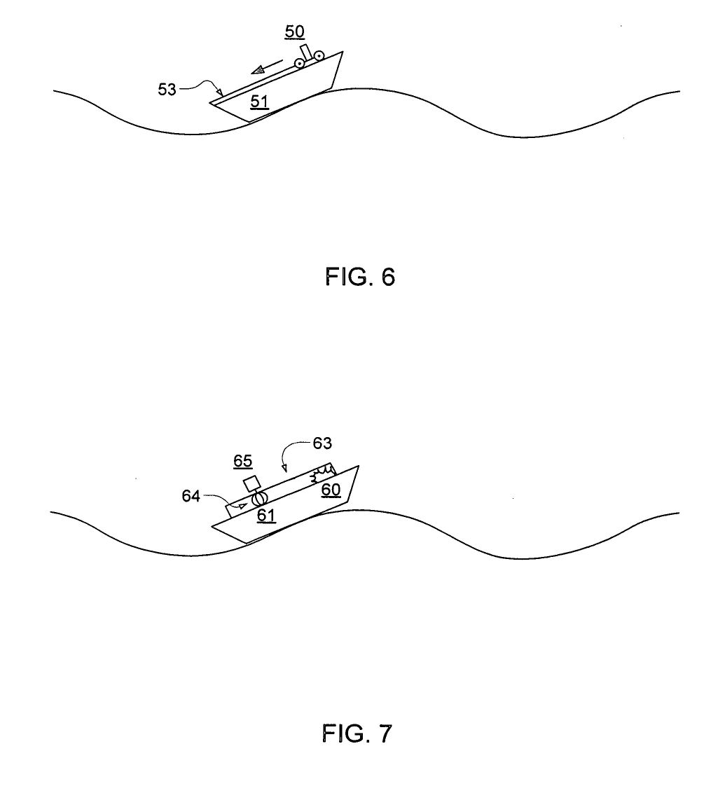

Another preferred embodiment is shown in FIG. 6. In this embodiment, a wheeled vehicle 50 rolls down an incline plane 51 on a track 53. The mechanical energy of the moving vehicle is converted to electricity by driving the shaft of an electric generator with a belt (not shown) attached to the axles or wheels of the wheeled vehicle 50. Alternatively, although it is not as efficient, the linear motion of the wheeled vehicle 50 can be converted into rotary motion to drive an electric generator via a screw drive or other means known to those skilled in the art. This approach also allows the generator to be fixed to the platform, as opposed to the embodiments shown in FIGS. 4-5 in which the generator is fixed to the moving mass. It should be clear that, in practice, one or more moving masses can drive one generator or one moving mass can drive one or more generators.

In still another preferred embodiment, as shown in FIG. 7, a volume of a suitable liquid 60, such as water, can be used to flow down an incline plane 61. The flowing water 60 is diverted through a duct, pipe or other channel 63 to turbine 64. The flowing water drives the turbine 64 which, in turn, drives a generator 65. Various means known to those skilled in the art, such as separate channels, can be used to insure that the turbine is turned in the same direction by the flowing water regardless of the direction of the flow of the water as it flows down a series of reverse incline planes.

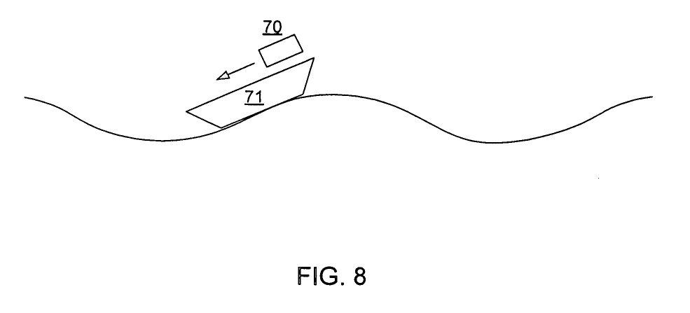

In still another embodiment, as shown in FIG. 8, a mass 70 can be suspended above an incline plane 71 by electromagnetic force. This will eliminate friction between the mass 70 and the incline plane 71. As the mass 71 moves down the incline plane, various means described above or known to those skilled in the art can be used to convert the mechanical energy of the motion into electricity.

Electricity generated by the present invention can be stored, for example in batteries, on the ship on which it is produced or can be transmitted concurrently with its production through underwater cables to the power grid.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

The invention claimed is:

1. A method for generating electricity using a mass moving down an incline plane, which plane is inclined by a wave, such method comprising,
floating a platform having a leading edge and a trailing edge on a body of water;
placing a mass on the platform,
utilizing a wave on the body of water to raise the leading edge of the platform over the trailing edge, thereby creating an incline plane,
allowing the mass to move down the incline plane thereby gaining mechanical energy, and
using the mechanical energy of the mass moving down the incline plane to turn a generator to produce electricity.

2. The method of claim 1 wherein the platform is a deck of a ship.

3. The method of claim 1 wherein the mass moving down the incline plane is sliding down the incline plane.

4. The method of claim 1 wherein the mass moving down the incline plane comprises one or more substantially cylindrical masses rolling down the incline plane.

5. The method of claim 1 wherein the mass moving down the incline plane comprises a wheeled vehicle rolling down the incline place.

6. The method of claim 1 wherein placing a mass on the platform comprises suspending a mass above the platform using electromagnetic force.

7. The method of claim 1 further comprising braking the mass moving down the incline plane before it reaches the trailing edge of the platform.

8. A method for generating electricity using a mass moving down a series of reverse incline planes, which planes are inclined by hydraulic forces of water in waves, such method comprising,
locating a body of water on which water in waves exerts hydraulic forces on floating objects,
floating a platform having a leading edge and a trailing edge on the body of water,
placing a mass on the platform,
utilizing said hydraulic forces alternately to raise the leading edge of the platform over the trailing edge and to raise the trailing edge of the platform over the leading edge, thereby creating a series of reverse incline planes,
allowing the mass to move down the reverse incline planes, thereby gaining mechanical energy, and
converting the mechanical energy of the mass moving down the reverse incline planes into electrical energy.

9. The method of claim 8 wherein the mass moving down the incline plane is sliding down the incline plane.

10. The method of claim 8 wherein the mass moving down the incline plane comprises one or more substantially cylindrical masses rolling down the incline plane.

11. The method of claim 8 wherein the mass moving down the incline plane comprises a wheeled vehicle rolling down the incline place.

12. The method of claim 8 wherein placing a mass on the platform comprises suspending a mass above the platform using electromagnetic force.

13. The method of claim 8 further comprising braking the mass moving down the incline planes before it reaches either the trailing edge or the leading edge of the platform.

14. A method for generating electricity using a volume of liquid flowing down an incline plane, which plane is inclined by a wave, such method comprising,
floating a platform having a leading edge and a trading edge on a body of water,
placing a volume of liquid on the platform,
utilizing a wave on the body of water to raise the leading edge of the platform over the trailing edge, thereby creating an incline plane,
allowing the liquid to flow down the incline plane, thereby turning a turbine, and
using the turning turbine to turn a generator to produce electricity.

15. A system for generating electricity using a mass moving down a series of reverse incline planes, which planes are inclined by hydraulic forces of water in waves, such system comprising,
a platform with a leading edge and a trailing edge floating on a body of water on which water in waves exerts hydraulic forces on floating objects,
a mass placed on the platform such that the mass gains mechanical energy by moving down reverse incline planes created by said hydraulic forces acting on the platform, and
means to convert the mechanical energy of the mass moving down the reverse incline planes into electrical energy.

16. The system of claim 15 wherein the means to convert the mechanical energy of the mass moving down the reverse incline planes into electrical energy further comprises a belt drive and a generator.

17. The system of claim 15 wherein the means to convert the mechanical energy of the mass moving down the reverse incline planes into electrical energy further comprises a srew drive and a generator.
